(19) United States
(12) Patent Application Publication
(10) Pub. No.: US 2003/0167760 A1
(43) Pub. Date: Sep. 11, 2003

(54) Self-powered-hydro-electric-power generator

(76) Inventor: Robert William Jackson, Hinton, OK (US)

Correspondence Address: Robert William Jackson, 3309 Jomar Dr, Plano, TX, 75075, US

(21) Appl. No.: 10/136,521

(22) Filed: May 1, 2002

Related U.S. Application Data
(60) Provisional application No. 60/363,271, filed on Mar. 11, 2002.
(60) Provisional application No. 60/368,394, filed on Mar. 29, 2002.

(51) Int. Cl. F16D 31/00

(52) U.S. Cl. 60/325

(57) ABSTRACT

My concept of using pressurized water to generate electric power is more efficient and is environmentally friendly than other methods in use today. Thrust from water flow would produce torque by rotating the turbine which is connected to an electric generator. I believe this method to be more efficient than steam, internal combustion, or coal burning methods.

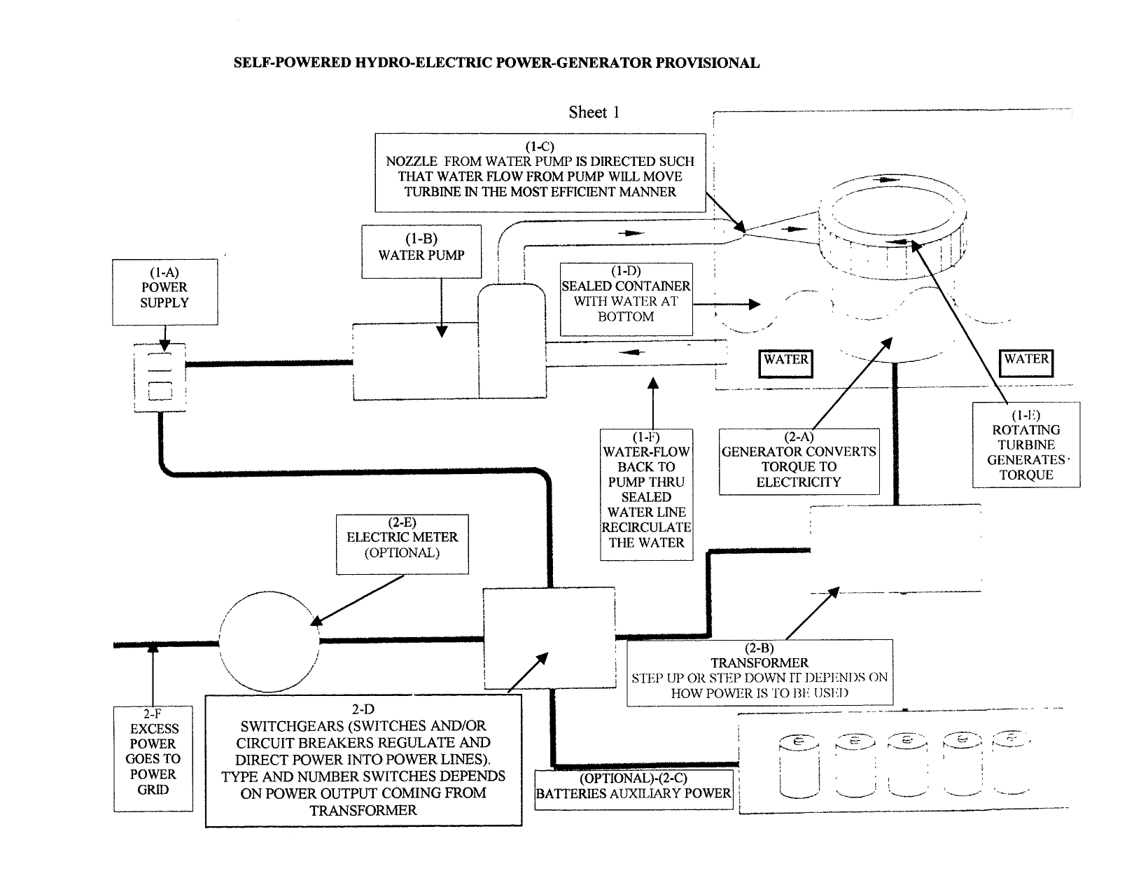

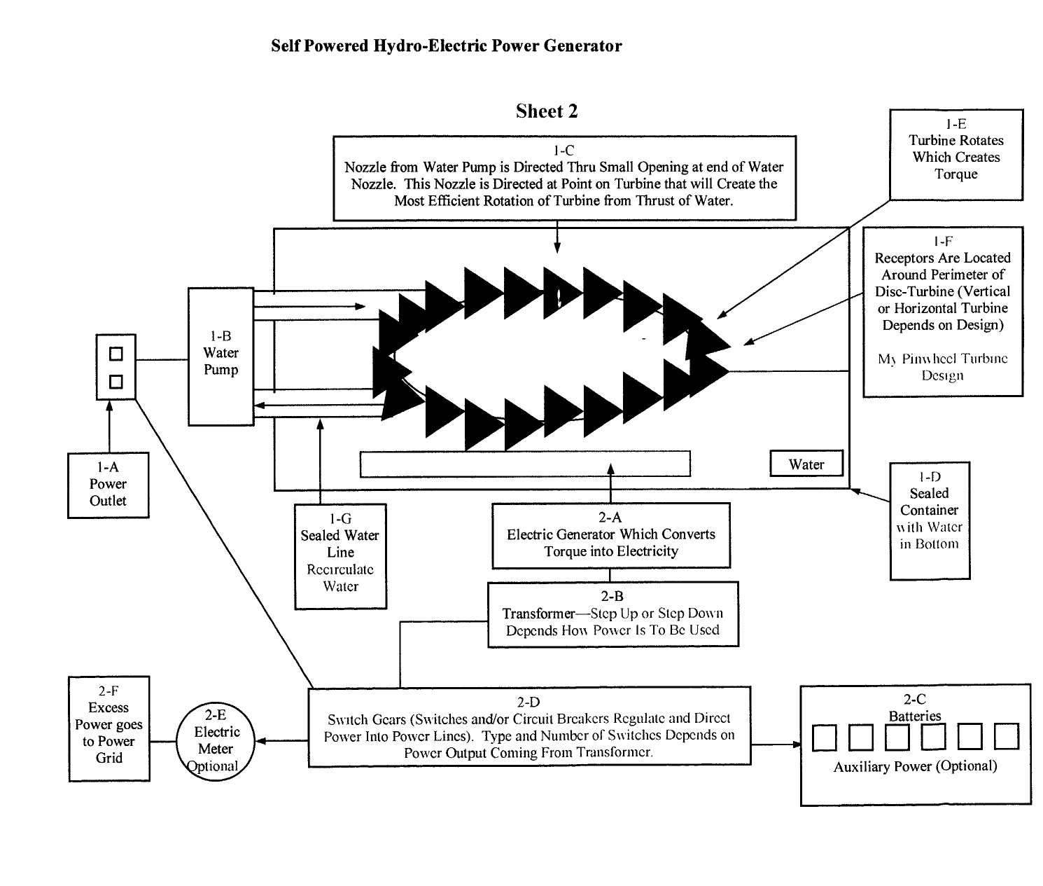

### CROSS-REFERENCE TO RELATED APPLICATIONS

Robert William Jackson requests that provisional patent No. 60/363,271 (Self Powered Hydro-Electric Power Generator) Date Mar. 11, 2002 be converted into utility patient Confirmation Number 4014

Robert William Jackson requests that Disclosure Document Number 506280 (Self Contained Water Power Generator) Date Feb. 28, 2002 also be included into this application.

Robert Jackson requests that this particular utility patent be classified as a “Concept” Patent.

Robert William Jackson claims to be sole inventor of this concept and has tried to meet the requirements for filing a utility patent.

### BACKGROUND OF THE INVENTION

### Classification of Definitions

This theory was developed by Robert William Jackson. I claim to be the original inventor of this concept. This is a renewable energy device using basic hydro-electric principals. My idea is to reuse the water that rotates a hydro-electric turbine (any turbine that can rotate by water flow) The turbine is connected to an electric generator. You recirculate the same water that was used originally to rotate turbine by using a water pump (see drawings).

### BRIEF SUMMARY OF THE INVENTION

My theory is you can generate more electricity from the hydro-electric generator than what it takes to run the water-pump which powers the generator. This invention is intended to produce electric power more efficiently than other methods in use at this time. I recommend the water to be recirculated even though this is not necessary to the power output potential of the device.

### DETAILED DESCRIPTION OF THE INVENTION

This is a description of a concept. I'm using one-water pump. Power used to run the water pump depends on the type of water pump that is used. The water pump also needs to be able to pump its own water from a reservoir of water that is located at the bottom of a sealed and watertight container. A rectangular shape for the container is recommended. The container needs to be large enough to hold adequate amount of water to keep water-pump operating at full potential. The water level needs to be maintained at this level due to evaporation. I recommend water temperature between 40° to 90° for optimum performance. The height of the container needs to be high enough so turbine is above the water line. Also the container needs to be long enough so that the turbine is not too close to the back of the container. This prevents any back splash of water that might impede the rotation of the turbine. This also leaves room for a second turbine which can be lined up to capture excess thrust from water that first turbine didn't capture. I call this excess water “tailwater.” This concept uses impulse turbines even though reaction type turbines (submerged turbines) could be used with this concept as long as power generated is more than power used to run water pump. This concept can be used anywhere as long as adequate amounts of water is available to run device.

Nozzle from the water pump is inserted into the container. The nozzle has a small opening. It should be the width which produces the highest PSI (Pounds Per Square Inch Pressure) rating the water pump can produce. The end of the nozzle is directed at the point on the turbine that will create the most efficient rotation of the turbine from the thrust of the water.

The electric generator can either be in or out of the container. If the generator is in the container, it needs to be waterproof. If the electric generator is located outside of the container, the container needs to be watertight. This means that the opening in the container that the spindle from the generator is inserted into is watertight. The turbine inside the container is connected to the spindle. The spindle is either part of the armature or is directly connected to the armature of the generator. A round ring of ball bearings should be located in this opening with the spindle or armature inserted through this ring. This would also help stabilize the electric generator which is essential to the operation of this device. The water pump and the nozzle also need to be in a fixed position. The water pump also could be located inside the container as long as the water pump is waterproof. I think the life of the water-pump and electric generator would be extended is located outside of the container. A completely sealed device would take up less space though.

I believe the higher the pounds per square inch (PSI) rating of the water-pump directly increases the power potential of the device. The pump, generator and design of the turbine all need to be in the proper ratio. This means the generator and turbine need to be capable of generating more power than what it takes to run water-pump at the same time the water-pump needs to be capable of producing enough force to generate this amount of electricity and the ability to pump this amount of water for an extended amount of time. The nozzle and turbine needs to be in proper alignment for the most efficient operation of this device. This deals with the maximum rotation of turbine due to the PSI pressure of the water coming from the pump. This creates torque which the generator converts into electricity. I envision a water-pump which you can adjust the water pressure (PSI). This would enable you to adjust the power output of the device. The power it takes to run-water pump would decrease or increase accordingly to the water pressure (PSI).

This unit does require initial start-up. There is a lot of ways of doing this from batteries other generators, or from any standard power source. Any excess power can be stored in batteries, so that if you use the device on a regular basis, the batteries would be able to start the device at anytime. An alternating current (AC) generator would work best if you are transferring electricity into the power grid or you're transporting the electricity over a long distance.

The turbine design is very important. I think the Pelton, Harris Nautilus, Neptune and the Banki turbines would work excellent with my concept. The Kaplan, Francis and basic water wheels would also be good choices in my opinion.

I have designed my own turbine. It is called the Pinwheel turbine. This design is patterned after the Pinwheel firework. I believe the best position for the Pinwheel Turbine is horizontal with the spindle or armature being vertical but I believe a vertical position would be very efficient, too. The spindle or armature would be horizontal if turbine was vertical. The type of generator would determine the best position of the turbine and the type of turbine to be used.

My design has the disc being solid even though a spoke design could be effective, too. The round disc design has to be strong and sturdy to withstand high pressure over a prolonged period of time. I believe the disc should have at least 12 receptor cones positioned around the perimeter of the disc (dimensions are patterned after the Pinwheel firework). These receptors should be spaced evenly. I also believe that the receptors should point slightly outward from the disc for maximum retention of the thrust from water coming from the pump. The size of the disc turbine shouldn't be much larger in diameter than the width of the generator on which it is connected (just not too big or small for maximum efficiency of rotation in which torque is created.

1. I claim my concept of using pressurized water is a highly efficient ways of generating Electric Power.

2. I claim my concept of using pressurized water to generate Electric Power to be non-pollution and environmentally friendly.

3. I claim my concept differs from existing hydro-electric generators because I use a water-pump to create the water pressure and I also recirculate the same water.

4. I claim my concept would be used with existing generators with a variety of turbines. Thrust from water flow would produce torque by rotating turbine which in turn generator concerts into electricity.

5. I claim you can connect multiple units together for larger power output.

6. I claim you can build a large generator with a high power output as long as you have the appropriate water pump and turbine. This could be in the form of a pressurized water reactor.

7. I claim my concept could be used in many ways, home, auto, industrial, recreational or emergency use, anywhere you can use electricity.

8. I claim this to be a perpetual power concept with enormous potential.
